(19) United States
(12) Patent Application Publication
(10) Pub. No.: US 2025/0239765 A1
(43) Pub. Date: Jul. 24, 2025

(54) NON-BROADSIDE BEAM ANTENNA WITH PHASE VARIABILITY

(71) Applicant: John Howard, Upper Mount Bethel, PA (US)

(72) Inventors: John Howard, Upper Mount Bethel, PA (US); Rana Barsbai, East Brunswick, NJ (US); Steve Jalil, Dover, NJ (US)

(73) Assignee: John Howard, Upper Mount Bethel, PA (US)

(21) Appl. No.: 19/010,344

(22) Filed: Jan. 6, 2025

Related U.S. Application Data
(60) Provisional application No. 63/622,718, filed on Jan. 19, 2024.

(51) Int. Cl. H01Q 3/36

(52) U.S. Cl. CPC H01Q 3/36

(57) ABSTRACT

An antenna is configured to transmit a first electromagnetic signal at full power using a first set of radiating elements and to transmit the first electromagnetic signal at an attenuated power using a second set of radiating elements to decrease at least one side lobe associated with transmission of the first electromagnetic signal. The antenna is configured to receive a second electromagnetic signal having an associated first power level using the second set of radiating elements and to form an aggregated electromagnetic signal having a second power level that is a multiple of the first power level. The antenna is configured to attenuate the aggregated signal to form an attenuated electromagnetic signal having a third power level to facilitate uniform reception of the second electromagnetic signal and tapered transmission. A phase shifter is configured to be operatively coupled between (1) a transceiver and (2) at least one of the radiating elements in at least one of the first set of radiating elements and the second set of radiating elements, thereby enabling at least one of reception and transmission of non-zero mode and non-broadband electromagnetic signals.

### CROSS-REFERENCE TO RELATED APPLICATION

This application claims the benefit of and priority to U.S. Provisional Application No. 63/622,718, filed Jan. 19, 2024, the disclosure of which is incorporated herein by reference in its entirety.

### BACKGROUND

The disclosed embodiments generally relates to antennas, and more particularly relate to broadside and non-broadside beam antennas.

### SUMMARY

An array antenna can include a number of transmitting/receiving elements. Tapering is preferably achieved by applying specific attenuation to one or more sets of radiating elements. The attenuation applied to these radiating elements can have the effect of decreasing the sidelobes of the overall antenna. Typically, however, when the antenna receives a signal, the effect of tapering is still apparent, and thus the reception is non-uniform. This non-uniform reception is often detrimental to the receiving system and can cause a decrease in isolation when associated with a beamforming network connected to an input of a phased array antenna. Therefore, it is beneficial and advantageous to taper transmission without tapering reception.

In some aspects, a device for transmitting and receiving electromagnetic signals includes an antenna. The antenna is configured to transmit a first electromagnetic signal at full power using a first set of radiating elements and to transmit the first electromagnetic signal at an attenuated power using a second set of radiating elements, thereby decreasing at least one side lobe level associated with transmission of the first electromagnetic signal. The antenna is configured to receive a second electromagnetic signal having an associated first power level using the second set of radiating elements and to form an aggregated electromagnetic signal having a second power level that is a multiple of the first power level. The antenna is configured to attenuate the aggregated signal to form an attenuated electromagnetic signal having a third power level to facilitate uniform reception of the second electromagnetic signal and tapered transmission.

In other aspects, a method for receiving and transmitting an electromagnetic signal is disclosed. The method includes radiating a first electromagnetic signal at full power using a first set of radiating elements, radiating the first electromagnetic signal at an attenuated power using a second set of radiating elements, thereby decreasing at least one side lobe level associated with transmission of the first electromagnetic signal, and receiving a second electromagnetic signal having an associated first power level using the second set of radiating elements. The method also includes forming an aggregated electromagnetic signal having a second power level that is a multiple of the first power level and attenuating the aggregated signal to form an attenuated electromagnetic signal having a third power level to facilitate uniform reception of the second electromagnetic signal and tapered transmission.

In yet other aspects, an antenna configured for tapered transmission and untapered reception is disclosed. The antenna includes radiating elements, a power manipulation unit, and an attenuator. The radiating elements are configured to receive an electromagnetic signal propagating through a medium and to convert the electromagnetic signal into guided electromagnetic signals. The power manipulation unit is operatively coupled to a set of the radiating elements. The power manipulation unit is configured to aggregate the guided electromagnetic signals received by the set of the radiating elements to form an aggregated signal. The attenuator is operatively coupled to the power manipulation unit to receive the aggregated signal. The attenuator is configured to attenuate the aggregated signal to facilitate uniform reception.

Aspects of the disclosed embodiments will become apparent upon consideration of the disclosed preferred embodiments, particularly when taken in conjunction with the accompanying drawings, wherein like reference numerals in the various figures are utilized to designate like components.

### BRIEF DESCRIPTION OF THE DRAWINGS

The following drawings are provided by way of example only and without limitation, wherein like reference numerals (when used) indicate corresponding elements throughout the several views, and wherein:

FIG. 1 depicts a block diagram of a polypod antenna in accordance with a first embodiment, which is used with beamformers that incorporate a zero mode or broadside beam;

FIG. 2 depicts an arrangement of radiating elements of a polypod antenna in accordance with one or more embodiments disclosed herein;

FIG. 3 depicts a block diagram of a polypod antenna in accordance with a second embodiment, which is used with beamforming networks that incorporate a non-zero mode or non-broadside beam; and

FIG. 4 depicts a block diagram of a polypod antenna in accordance with a third embodiment, which is used with beamforming networks that incorporate a non-zero mode or non-broadside beam.

It is to be appreciated that elements in the figures are illustrated for simplicity and clarity. Common but well-understood elements that are useful or necessary in a commercially feasible embodiment are not shown in order to facilitate a less hindered view of the illustrated embodiments.

### DETAILED DESCRIPTION

The disclosed embodiments are directed to polypod antennas that utilize a technique for achieving tapered transmission on an antenna array while maintaining uniformity when receiving. The polypod antennas achieve tapered transmission and non-tapered reception by utilizing a combination of attenuators and power manipulation units. The attenuators are preferably disposed in or outside the feed network of the antenna array in order to attenuate a desired set of radiating elements. To eliminate or counteract the attenuation when receiving with the polypod antenna, the quantity of elements for the attenuated set of radiating elements is increased.

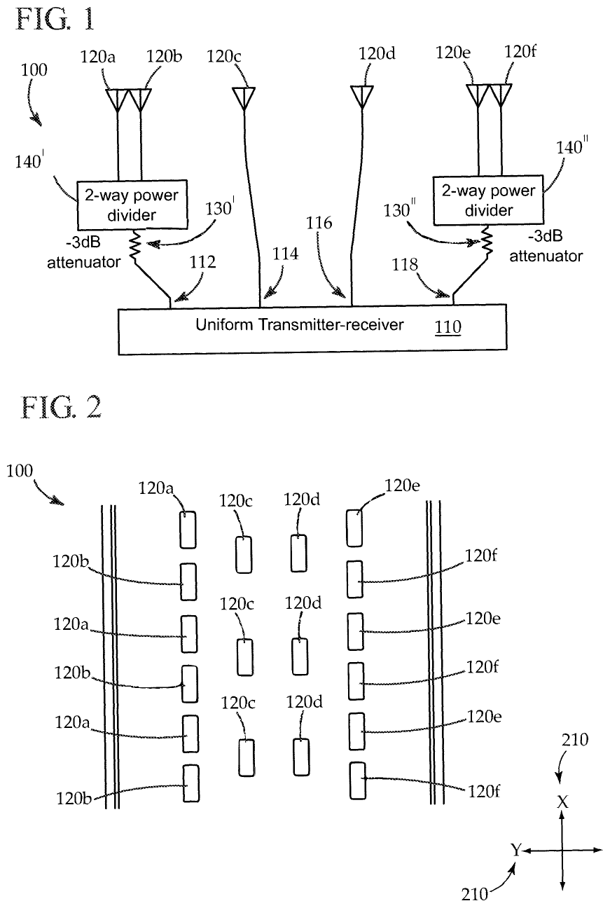

FIG. 1 depicts an exemplary block diagram of an embodiment of the polypod antenna 100, which is used with beamformers that incorporate a zero mode or broadside beam. The polypod antenna 100 preferably includes a transceiver 110, radiating elements 120a-f, attenuators 130′ and 130″ (collectively referred to herein as “attenuators 130), and power manipulation units 140′ and 140″ (collectively referred to herein as “power manipulation units 140). The power manipulation units 140 can include power dividers, which distribute or divide power associated with one or more signals between multiple radiating elements, and/or a power aggregator, which aggregates or multiplies power associated with one or more signals to form a signal with amplified, intensified, or multiplied power.

The transceiver 110 is preferably adapted to transmit and/or receive electromagnetic signals via the radiating elements 120a-f. The transceiver 110 can include a plurality of connecting feed lines. In this example, the transceiver 110 includes four connecting feed lines 112-118. The two center radiating elements 120c-d are preferably connected to the transceiver 110 via connecting feed lines 114 and 116, respectively, without any attenuation. The sets of side radiating elements 120a-b and 120e-f are preferably connected to the transceiver 110 through attenuators 130 and power manipulation units 140 via connecting feed lines 112 and 118, respectively.

The radiating elements 120a-f can receive free space electromagnetic signals propagating through the air and/or can transmit guided electromagnetic signals by radiating electromagnetic signals received from the transceiver 110.

Attenuators 130 attenuate the sets of radiating elements 120a-b and 120e-f, respectively, to provide tapered guided electromagnetic signals passing to the sets of radiating elements 120a-b and 120e-f. In this manner, the set of radiating elements 120a-b and the set of radiating elements 120e-f radiate an attenuated version of the guided electromagnetic signal, while the radiating elements 120c-d radiate the guided electromagnetic signal at full power. For example, the attenuators 130 can reduce the power of a signal that passes through the attenuator by one half (e.g., 3 dB) or by alternative attenuation factors. The attenuation applied to sets of radiating elements 120a-b and 120e-f can preferably have the effect of decreasing the at least one of the sidelobe levels of the polypod antenna 100 during transmission, which results in tapered transmission.

The power manipulation units 140 distribute signal power between the radiating elements connected to the power manipulation units 140. For example, the radiating elements 120a-b are connected to the power manipulation unit 140′. Signal power is distributed between radiating elements 120a-b via the power manipulation unit 140′. Likewise, the radiating elements 120e-f are connected to the power manipulation unit 140″. Signal power is distributed between the radiating elements 120e-f via the power manipulation unit 140″.

During transmission, a guided electromagnetic signal to be transmitted is sent from the transceiver 110 to the radiating elements 120a-f via the connecting feed line 112-118. The connecting feed line 114 guides the electromagnetic signal to the radiating element 120c. The connecting feed line 116 guides the electromagnetic signal to the radiating element 120d. The connecting feed line 112 guides the electromagnetic signal through the attenuator 130′, in which the electromagnetic signal is attenuated. Subsequently, the attenuated signal enters the power manipulation unit 140′, in which the attenuated signal is distributed between the radiating elements 120a-b. Likewise, the connecting feed line 118 guides the electromagnetic signal through the attenuator 130″ and the power manipulation unit 140″ to the radiating elements 120e-f. The power manipulation unit 140″ distributes the signal power between the radiating elements 120e-f. The radiating elements 120c-d radiate the signal at full power and the sets of radiating elements 120a-b and 120e-f radiate the attenuated signals.

For example, during transmission, the transceiver 110 may pass a one (1) power unit signal through each of the connecting feed lines 112-118. Each of the connecting feed lines 114 and 116 can guide the one (1) power unit signal to the radiating elements 120c and 120d, respectively. Each of the radiating elements 120c-d can then radiate the one (1) power unit signal. Each of the connecting feed lines 112 and 118, however, guides the one (1) power unit signal through the attenuators 130 to reduce the one (1) power unit signal to a ½ power unit signal. The ½ power unit signal is passed through the power manipulation units 140, which distribute the ½ power unit signal via the connecting feed line 112 between the radiating elements 120a-b and distributes the ½ power unit signal via the connecting feed lines 118 between the radiating elements 120e-f. In one embodiment, the power manipulation units 140 distribute the ½ power unit signal equally, such that each of the radiating elements 120a-b and 120e-f radiate a ¼ power unit signal.

During reception, each of the radiating elements 120a-f receives a free space electromagnetic signal propagating through a medium, such as air. The free space electromagnetic signal received by the radiating elements 120c-d is preferably guided by connecting feed line 114 and 116, respectively, to the transceiver 110. The free space electromagnetic signal received by the radiating elements 120a-b is converted into a guided electromagnetic signal that is guided through the power manipulation unit 140′, in which the electromagnetic signals from each of the radiating element 120a-b are combined. This combination creates an intensified or aggregated signal, the power of which is based on the quantity of radiating elements 120a-b that are used. The intensified signal passes through the attenuator 130′, in which the intensified signal is attenuated. As a result of the attenuation, the power of the intensified signal is reduced. The signal received by the radiating elements 120e-f can undergo the same process as the signal received by radiating elements 120a-b. The quantity of radiating elements 120 for the sets of radiating elements 120a-b and 120e-f is configured to compensate for the attenuation during reception of a signal by the sets of radiating elements 120a-b and 120e-f.

For example, during reception, the attenuators 130 may reduce the power of a signal on the connecting feed lines 112 and 118 by one half (½). In this example, each connecting feed line 112 and 118 that includes attenuators 130 includes two radiating elements 120a-b and 120e-f that are configured to compensate for attenuation of the attenuators 130. The antenna 100 may receive a one (1) power unit signal with each of the radiating elements 120a-b. The one (1) power unit signal from each radiating elements 120a-b passes through the power manipulation unit 140′, which combines the one (1) power unit signal from each of the radiating elements 120a-b to form a two (2) power unit signal. Subsequently, the two (2) power unit signal passes through the attenuator 130′, which reduces the two (2) power unit signal by one half (½) to form a one (1) power unit signal. The one (1) power unit signal is guided by the connecting feed line 112 to the transceiver 110 for processing. As a result, the transceiver 110 receives a signal that accurately represents the signal received by the antenna 100.

Accordingly, the polypod antenna 100 transmits a tapered signal via the sets of radiating elements 120a-b and 120e-f as a result of the attenuation performed by the attenuators 130. During reception, however, because there are sets of multiple radiating elements 120a-b and 120e-f for each attenuated connecting feed line 112 and 118, where each set can aggregate the signals, the attenuation is compensated.

FIG. 2 depicts an arrangement of radiating elements 120 in accordance with one or more disclosed embodiments. The sets of radiating elements 120a-b and 120e-f are constructed by placing the radiating elements 120a-b in close proximity to each other and by placing the radiating elements 120e-f in close proximity to each other. However, an appropriate distance is preferably maintained between the radiating elements 120a-b, as well as between the radiating elements 120e-f, so that there is no gain reduction due to effective area overlap.

The sets of radiating elements 120a-b and 120e-f can be arranged along an x-axis 210 or a y-axis 220. In one or more disclosed embodiments, the set of radiating elements 120a-b is aligned along the y-axis 220 as is the set of radiating elements 120e-f. This arrangement enables the horizontal beamwidth of each set of radiating elements 120a-b and 120e-f to have the same horizontal beamwidth as the single elements associated with the set of radiating elements 120c-d of the array.

While exemplary embodiments depict sets of two (2) radiating elements 120a-b and 120e-f for each attenuated connecting feed line 112 and 118, respectively, one skilled in the art will appreciate that any number of radiating elements can be used for each attenuated connecting feed line. In addition, the quantity of radiating elements for each set can be based on the amount of attenuation used.

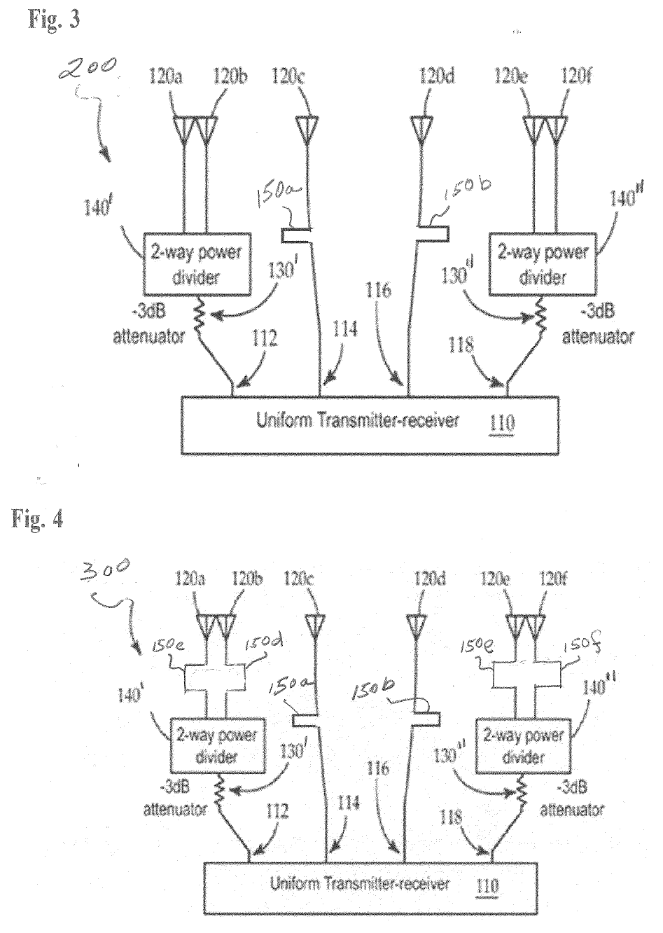

The type of power divider shown in FIG. 1 has no phase variation, and is thus limited to being used with beamformers that have a zero mode or broadside beam. FIG. 3 depicts a block diagram of a polypod antenna 200 in accordance with a second embodiment, which is used with beamformers that incorporate a non-zero mode or non-broadside beam. In cases in which a non-zero mode or non-broadside beam is used, the bank of power dividers is configured to operatively couple one or more N-way phase shifters 150a-b, where N is an integer greater than or equal to two, between the uniform transmitter-receiver 110 and radiating elements 120a-f as illustrated in FIG. 3. Specifically, the uniform transmitter-receiver 110 is operatively coupled to the N-way phase shifter 150a, wherein N is equal to an integer greater than or equal to two, which is operatively coupled to radiating element 120c. Similarly, the uniform transmitter-receiver 110 is operatively coupled to the N-way phase shifter 150b, which is operatively coupled to radiating element 120c. It is to be noted that the phases of the N-way phase shifters are arbitrary and depend on the direction of the beams desired to be configured in any particular implementation.

FIG. 4 depicts a block diagram of a polypod antenna 300 in accordance with a third embodiment, which is also used with beamformers that incorporate a non-zero mode or non-broadside beam. In the third embodiment, the N-way power divider 140′ is operatively coupled to a phase shifter 150c, wherein N is equal to an integer greater than or equal to two, which is operatively coupled to radiating element 120a. Similarly, the N-way power divider 140′ is operatively coupled to a phase shifter 150d, which is operatively coupled to radiating element 120b. In addition, the N-way power divider 140″ is operatively coupled to a phase shifter 150e, which is operatively coupled to radiating element 120e. Similarly, the N-way power divider 140″ is operatively coupled to a phase shifter 150f, which is operatively coupled to radiating element 120f. As indicated above, it is to be noted that the phases of the N-way phase shifters are arbitrary and depend on the direction of the beams specified in a particular implementation.

The illustrations of embodiments described herein are intended to provide a general understanding of the structure of various embodiments, and the embodiments are not intended to serve as a complete description of all the elements and features of apparatus and systems that might make use of the structures described herein. Many other embodiments will be apparent to those skilled in the art upon reviewing the above description. Other embodiments are utilized and derived therefrom, such that structural and logical substitutions and changes are made without departing from the scope of this disclosure. Figures are also merely representational and are not drawn to scale. Certain proportions thereof are exaggerated, while others are decreased. Accordingly, the specification and drawings are to be regarded in an illustrative rather than a restrictive sense.

Such embodiments are referred to herein, individually and/or collectively, by the term “embodiment” merely for convenience and without intending to voluntarily limit the scope of this application to any single embodiment or inventive concept if more than one is in fact shown. Thus, although specific embodiments have been illustrated and described herein, it should be appreciated that any arrangement calculated to achieve the same purpose are substituted for the specific embodiments shown. This disclosure is intended to cover any and all adaptations or variations of various embodiments. Combinations of the above embodiments, and other embodiments not specifically described herein, will be apparent to those skilled in the art upon reviewing the above description.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single embodiment. Thus, the following claims are hereby incorporated into the detailed description, with each claim standing on its own as a separate example embodiment.

The abstract is provided to comply with 37 C.F.R. § 1.72(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single embodiment. Thus, the following claims are hereby incorporated into the Detailed Description, with each claim standing on its own as separately claimed subject matter.

Although specific example embodiments have been described, it will be evident that various modifications and changes are made to these embodiments without departing from the broader scope of the inventive subject matter described herein. Accordingly, the specification and drawings are to be regarded in an illustrative rather than a restrictive sense. The accompanying drawings that form a part hereof, show by way of illustration, and without limitation, specific embodiments in which the subject matter are practiced. The embodiments illustrated are described in sufficient detail to enable those skilled in the art to practice the teachings herein. Other embodiments are utilized and derived therefrom, such that structural and logical substitutions and changes are made without departing from the scope of this disclosure. This Detailed Description, therefore, is not to be taken in a limiting sense, and the scope of various embodiments is defined only by the appended claims, along with the full range of equivalents to which such claims are entitled.

Given the teachings provided herein, one of ordinary skill in the art will be able to contemplate other implementations and applications of the techniques of the disclosed embodiments. Although illustrative embodiments have been described herein with reference to the accompanying drawings, it is to be understood that these embodiments are not limited to the disclosed embodiments, and that various other changes and modifications are made therein by one skilled in the art without departing from the scope of the appended claims.

What is claimed is:

1. A device configure to transmit and receive electromagnetic signals comprising:
an antenna configured to transmit a first electromagnetic signal at full power using a first set of radiating elements and to transmit the first electromagnetic signal at an attenuated power using a second set of radiating elements such that by the first and second sets of radiating elements is tapered and at least one side lobe level associated with transmission of the first electromagnetic signal is decreased, the antenna configured to receive a second electromagnetic signal from a first radiating element of the second set of radiating elements, the second electromagnetic signal having an associated first power level, the antenna being configured to form an aggregated electromagnetic signal having a second power level that is a multiple of the first power level, the aggregated electromagnetic signal comprising the second electromagnetic signal aggregated with at least one additional electromagnetic signal received by a second radiation element of the second set of radiating elements, the antenna configured to attenuate the aggregated signal to form an attenuated electromagnetic signal having a third power level, the second power level being a multiple of the first power level, the multiple compensating for the attenuation such that the third power level is equal to the first power level, the antenna providing uniform non-tapered reception of the first electromagnetic signal and tapered transmission of the second electromagnetic signal; and
a phase shifter configured to be operatively coupled between (1) a transceiver and (2) at least one of the radiating elements in at least one of the first set of radiating elements and the second set of radiating elements, thereby enabling at least one of reception and transmission of non-zero mode and non-broadband electromagnetic signals.

2. The device of claim 1, wherein the multiple is based on a quantity of radiating elements in the second set of radiating elements.

3. The device of claim 1, wherein the multiple is equal to a quantity of radiating elements in the second set of radiating elements.

4. The device of claim 1, wherein the third power level associated with the attenuated electromagnetic signal is a factor of the second power level associated with the aggregated electromagnetic signal.

5. The device of claim 1, wherein the third power level is substantially equal to a quotient of the second power level divided by a quantity of radiating elements in the second set of radiating elements.

6. The device of claim 1, wherein the third power level is substantially equal to the first power level.

7. The device of claim 1, wherein the second set of radiating elements includes at least two radiating elements and the second power level is approximately twice the first power level

8. The device of claim 1, wherein the transceiver is configured to transmit and receive the first and second electromagnetic signals using the first and second sets of radiating elements.

9. The device of claim 1, wherein the second set of radiating elements is operatively coupled to the transceiver through a power manipulation unit and an attenuator.

10. A method for receiving and transmitting an electromagnetic signal comprising:
radiating a first electromagnetic signal at full power using a first set of radiating elements;
radiating the first electromagnetic signal at an attenuated power using a second set of radiating elements such that transmission by the first and second sets of radiating elements is tapered and at least one side lobe associated with transmission of the first electromagnetic signal is decreased;
receiving a second electromagnetic signal received from a first radiating element of the second set of radiating elements, the second electromagnetic signal having an associated first power level;
forming an aggregated electromagnetic signal having a second power level that is a multiple of the first power level, the aggregated electromagnetic signal comprising the second electromagnetic signal aggregated with at least one additional electromagnetic signal received by a second radiation element of the second set of radiating elements,
attenuating the aggregated signal to form an attenuated electromagnetic signal having a third power level, the second power level being a multiple of the first power level, the multiple compensating for the attenuation such that the third power level is equal to the first power level, the antenna providing uniform non-tapered reception of the first electromagnetic signal and tapered transmission of the second electromagnetic signal, and
operatively coupling a phase shifter between (1) a transceiver and (2) at least one of the radiating elements in at least one of the first set of radiating elements and the second set of radiating elements, thereby enabling at least one of reception and transmission of non-zero mode and non-broadband electromagnetic signals.

11. The method of claim 10, wherein the multiple is based on a quantity of radiating elements in the second set of radiating elements.

12. The method of claim 10, wherein forming an aggregated electromagnetic signal comprises multiplying a quantity of radiating elements in the second set of radiating elements by the first power level.

13. The method of claim 10, wherein the third power level associated with the attenuated electromagnetic signal is a factor of the second power level associated with the aggregated electromagnetic signal.

14. The method of claim 10, wherein attenuating the aggregated signal comprises dividing the second power level by a quantity of radiating elements in the second set to form the attenuated electromagnetic signal having the third power level.

15. The method of claim 10, wherein the third power level is substantially equal to the first power level.

16. An antenna configured for tapered transmission and untapered reception comprising:
a plurality of radiating elements configured to receive an electromagnetic signal and to convert the electromagnetic signal into guided electromagnetic signals;
a power divider coupled to a set of the plurality of radiating elements, the power divider configured to aggregate the guided electromagnetic signals received by at least two different radiating elements of the set of the plurality of radiating elements to form an aggregated electromagnetic signal;
an attenuator coupled to the power divider to receive the aggregated electromagnetic signal, the attenuator configured to attenuate the aggregated electromagnetic signal to facilitate uniform reception, the antenna configured to transmit a first electromagnetic signal at full power using a first set of radiating elements and to transmit the first electromagnetic signal at an attenuated power using a second set of radiating elements such that transmission by the first and second sets of radiating elements is tapered and at least one side lobe level associated with transmission of the first electromagnetic signal is decreased, the antenna configured to receive a second electromagnetic signal from a first radiating element of the second set of radiating elements, the second electromagnetic signal having an associated first power level, the antenna being configured to form the aggregated electromagnetic signal having a second power level that is a multiple of the first power level, the aggregated electromagnetic signal comprising the second electromagnetic signal aggregated with at least one additional electromagnetic signal received by a second radiation element of the second set of radiating elements, the antenna configured to attenuate the aggregated signal to form an attenuated electromagnetic signal having a third power level, the second power level being a multiple of the first power level, the multiple compensating for the attenuation such that the third power level is equal to the first power level, the antenna providing uniform non-tapered reception of the first electromagnetic signal and tapered transmission of the second electromagnetic signal; and
a phase shifter configured to be operatively coupled between (1) a transceiver and (2) at least one of the radiating elements in at least one of the first set of radiating elements and the second set of radiating elements, thereby enabling at least one of reception and transmission of non-zero mode and non-broadband electromagnetic signals.

17. The antenna of claim 16, wherein the phase shifter is an N-way phase shifter, N being equal to or greater than two.

18. The antenna of claim 16, wherein the aggregated electromagnetic signal has a power level that is a multiple of a power level of the guided electromagnetic signal, the multiple being based on a quantity of radiating elements in the second set of radiating elements.

19. The antenna of claim 18, wherein the multiple is equal to a quantity of radiating elements in the second set of radiating elements.

20. The antenna of claim 16, wherein the third power level associated with the attenuated electromagnetic signal is a factor of the second power level associated with the aggregated electromagnetic signal.
